(19) United States
(12) Patent Application Publication
(10) Pub. No.: US 2009/0150801 A1
(43) Pub. Date: Jun. 11, 2009

(54) SYSTEM AND METHOD TO HANDLE VANDALISM IN A VIRTUAL WORLD

(75) Inventors: Travis M. Grigsby, Austin, TX (US); Frank L. Jania, Chaple Hill, NC (US); Darren M. Shaw, Fareham (GB)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/950,767

(22) Filed: Dec. 5, 2007

(51) Int. Cl. G06F 3/048

(52) U.S. Cl. 715/757

(57) ABSTRACT

A method for operating a virtual world, the method including: selecting an action with respect to an object displayed in the virtual world wherein the action is for at least one of preventing and eliminating vandalism; and executing the action.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to controlling vandalism in a virtual world.

2. Description of the Related Art

A virtual world is an environment that is simulated by a computer processing system. The environment is similar to the environment on earth or the real world. The virtual world enables a user to inhabit the environment and interact with other users. Generally, the virtual world is similar to the real world in that the virtual world has rules that obey the laws of nature. Some of these laws include gravity and physics of motion. In addition, the virtual world has topography, accounts for real-time actions, and has communication between the users.

As with the real world, the virtual world can be subject to vandalism. Perpetrators of the vandalism may be referred to as vandals or “griefers.” Vandalism in the virtual world may include damage to structures or objects. Vandalism may also include damage to communications such as interruptions or distractions in a lecture.

Solutions to vandalism in the virtual world are similar to the solutions to vandalism in the real world. The solutions include policing and restricting entry. Restrictions to entry may be based upon authorized users or a list of known vandals. In addition, vandalism is sometimes tolerated so as not to inhibit the rights of users who abide by the policies of not allowing vandalism. These solutions may be somewhat limited in that these solutions do not take advantage of the properties that are used to create the virtual world.

Therefore, what are needed are techniques to control vandalism in the virtual world.

### SUMMARY OF THE INVENTION

The shortcomings of the prior art are overcome and additional advantages are provided through the provision of a method for operating a virtual world, the method including: selecting an action with respect to an object displayed in the virtual world wherein the action is for at least one of preventing and eliminating vandalism; and executing the action.

Also disclosed is a computer program product stored on machine readable media and including machine executable instructions for operating a virtual world, the product including instructions for: selecting by a user of the virtual world an action with respect to an object displayed in the virtual world that at least one of prevents and eliminates vandalism in the virtual world wherein the action comprises at least one of making the object invisible and providing a rule for determining how the object may be affected; applying the action to the object; and eliminating the action after a period of time.

Additional features and advantages are realized through the techniques of the present invention. Other embodiments and aspects of the invention are described in detail herein and are considered a part of the claimed invention. For a better understanding of the invention with advantages and features, refer to the description and to the drawings.

As a result of the summarized invention, technically we have achieved a solution which at least one of prevents and eliminates vandalism in a virtual world.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings, wherein like elements are numbered alike, in which:

FIG. 1 illustrates an exemplary embodiment of a processing system for implementation of the teachings herein;

FIG. 2 illustrates aspects of preventing vandalism in an image of a virtual world;

FIGS. 3A and 3B, collectively referred to as FIG. 3, illustrate aspects of eliminating vandalism in the image of the virtual world; and

FIG. 4 illustrates one example of a method for operating the virtual world.

The detailed description explains the preferred embodiments of the invention, together with advantages and features, by way of example with reference to the drawings.

### DETAILED DESCRIPTION OF THE INVENTION

The teachings include techniques for controlling vandalism in a virtual world. The techniques include a method for operating the virtual world. The method controls vandalism from at least two perspectives. In a first perspective, vandalism is controlled from the point of view of an object that may be vandalized. In a second perspective, vandalism is controlled from the point of view of a victim of vandalism. Before the techniques are discussed in detail, certain definitions are provided as a matter of convenience.

The term “virtual world” relates to an environment simulated by a computer processing system. In general, the virtual world operates using rules that enable a user to build objects or structures and communicate with other users. An “image” or view of the virtual world is generally accessed by a user via a display coupled to the computer processing system. Similarly, audio from the virtual world is accessed by a user via a speaker coupled to the computer processing system. The term “image” relates to a view of the virtual world. The term “vandalism” relates to certain actions performed by a user of the virtual world that offends other users. Generally, these actions may include objects, images and communications that are offending. These actions may also include damaging objects created by other users. The term “vandal” relates to a user of the virtual world who causes vandalism. The term “victim” relates to a user of the virtual world who is offended by certain images displayed in the virtual world or certain actions affecting the virtual world. The term “object” may include at least one of a person, a thing, a design, and writing displayed in the virtual world. The term “control” in the context of controlling vandalism relates to at least one of preventing and eliminating vandalism in the virtual world.

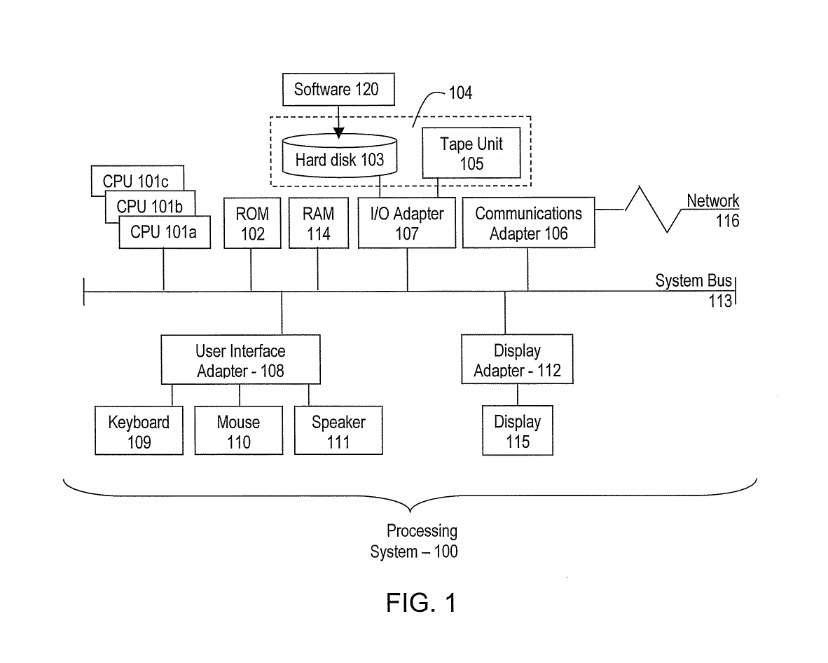

Referring to FIG. 1, there is shown an exemplary embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system.

The network 116 can be a local-area network (LAN), a metro-area network (MAN), or wide-area network (WAN), such as the Internet or World Wide Web. Users of the system 100 can connect to the network 116 through any suitable network interface connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 104) for capture and interactive display of information shown on the screen 115 of a user. As discussed herein, the instructions are referred to as “software” 120. The software 120 may be produced using software development tools as are known in the art. Also discussed herein, the software 120 may also referred to as a “vandalism control software” 120, or by other similar terms. The software 120 may include various tools and features for providing user interaction capabilities as are known in the art.

In some embodiments, the vandalism control software 120 is provided as an overlay to another program. For example, the vandalism control software 120 may be provided as an “add-in” to an application (or operating system). Note that the term “add-in” generally refers to supplemental program code as is known in the art. In such embodiments, the vandalism control software 120 may replace software structures or software objects of the application or operating system with which it cooperates.

The vandalism control software 120 generally provides a capability to operate the virtual world in such a way as to be able to at least one of prevent and eliminate vandalism. Commands to control vandalism are generally used in conjunction with other code used to operate the virtual world. The vandalism control software 120 and the code for operating the virtual world may be referred to as the “virtual world program.” The commands may be manually or automatically entered into the virtual world program. The commands may be native to (written to function within) computer application code programs (for example, C, C++, Perl, Java, JavaScript and others), other programs typically regarded as computing environments (UNIX, LINUX, DOS, and others) as well as other types of programs.

As a matter of convention herein, it is considered that the vandalism control software 120 provides for interfacing with other “computer code” used for operating the virtual world. It is recognized that computer code is commonly regarded as software, however, in the interest of avoiding confusion, use of the term “software” is generally limited to describing embodiments of computer implemented instructions and computer program products that provide for operating the virtual world to control vandalism.

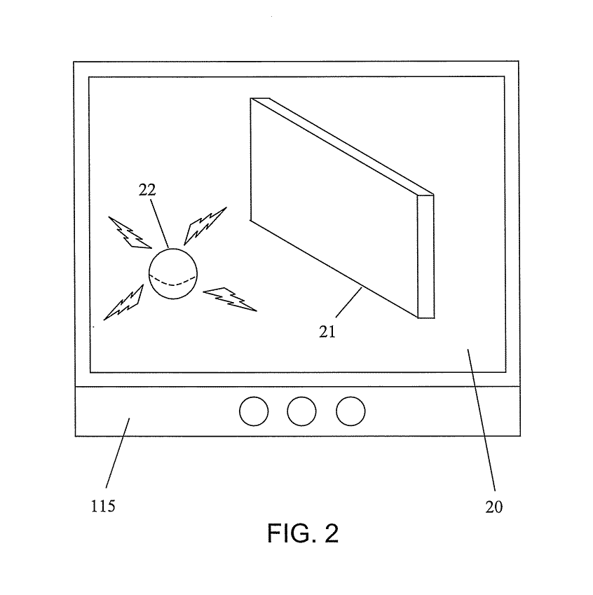

Now discussing the first perspective presented above, an object or structure may be created in the virtual world by a user. Referring to FIG. 2, an object 21 created by the user is included in a virtual world image 20. The virtual world image 20 is displayed by the display 115, which can be viewed by the user. Also illustrated in FIG. 2 is another object 22 that may affect the object 21. The user generally has intellectual property rights associated with the object 21. An owner of a location in the virtual world can determine if other users can build the another object 22 (or structures 22) on the location or “land.” In one embodiment of the techniques, the user establishes at least one rule governing how the another object 22 can affect the object 21. For example, the object 21 can be a wall (wall object 21) created by the user. The creator of the wall object 21 can establish a rule associated with the wall object 21. The associated rule can forbid the image of the wall object 21 from being distorted or impaired. For example, the associated rule can be enforced against the another object 22 to prevent the another object 22 from casting a shadow on the wall object 21. The associated rule can be enforced against one of all other users, a group of users, and other users not in a group.

In one example of enforcing the associated rule, another user may be allowed to build an explosive device (such as the other object 22 in FIG. 2) on the location of the wall object 21. However, the associated rule can prohibit the effects of an explosion of the explosive device from destroying or affecting the wall object 21. In this example, various methods can be used to enforce the associated rule that protects the wall object 21. In one method, all the calculations related to the physics of the explosion can be performed without the wall object 21 in place. In another method, the wall object 21 can be attributed with characteristics such as infinite density, infinite hardness, etc., which will render the explosion harmless to the wall object 21.

With respect to the second perspective presented above, an action or image is only vandalism when the action or image is perceived by a victim to be offensive. Therefore in one embodiment of the method for controlling vandalism, the victim may perform an action that stops the vandalism after the victim recognizes the vandalism. For example, the victim can “select” an offending object being displayed and make the offending object “invisible” to the victim. In one embodiment of the method, the victim can select and hide the offending object using the mouse 110.

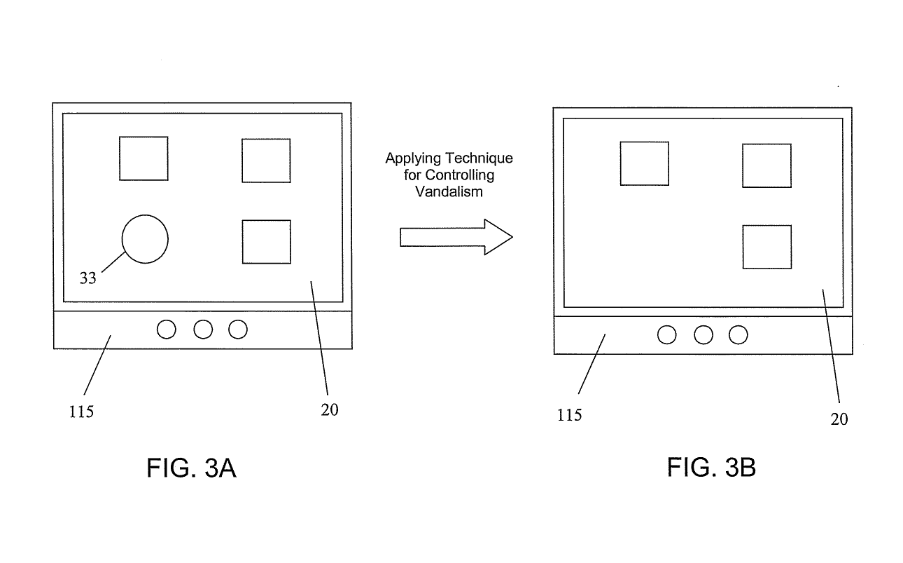

An example of implementation of the second perspective is illustrated in FIG. 3. Referring to FIG. 3A, an offending object 33 is included in the virtual world image 20. If the user finds the offensive object 33 to be offensive, then the user can select and hide the offensive object 33. FIG. 3B illustrates the virtual world image 20 with the offensive object 33 hidden from view.

In one embodiment of the method, the victim can hide all other objects created by the creator of the offending object 33. In one embodiment of the method, the offending object 33 can be modified visually. Examples of visual modifications include at least one of providing a wire frame model image of the offending object 33 and making the offending object 33 partially transparent. In one embodiment of the method, the user can toggle back and forth between visible objects and objects that have been at least one of made invisible and modified. In one embodiment of the method, one user can view an image through the “eyes” of another user with the other user's permission.

In one embodiment of the method, the rule associated with an object and an action taken by a victim to control vandalism can be set to expire after a period of time. In one embodiment of the method, the rule and the action can be enforced against a group of users that are determined to be potentially offensive. In one embodiment of the method, the rule can be applied to objects that are a subset of the object to which the rule was originally applied.

In one embodiment of the method, a user can choose to inherit from other users of a group to which the user belongs at least one of a rule associated with an object and an action that eliminated vandalism. In this embodiment, inheriting the rule or action may be automatic or accomplished after a threshold is exceeded.

The first and second perspectives discussed above may be combined such that a rule is provided by a specific user governing how that specific user chooses to view an object. As an example, the specific user can provide a rule for the wall object 21 that is individualized for the specific user. In this example, the rule can indicate to the virtual world that the specific user chooses to make invisible any object that obstructs the specific user's view of the wall object 21. If, in this example, a vandal were to build an object that looked like graffiti on the wall object 21, then the graffiti will be blocked from the view of the specific user.

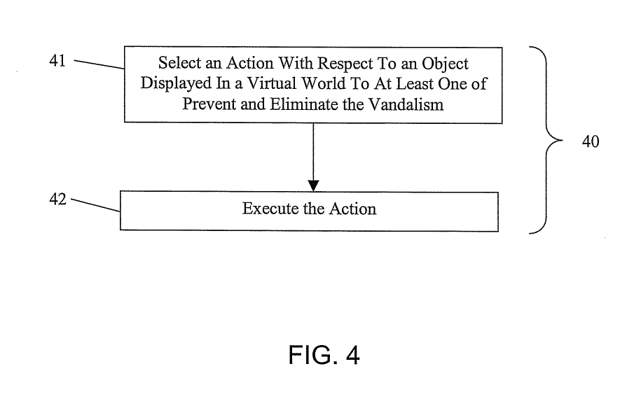

FIG. 4 presents one example of a method 40 for operating a virtual world. The method 40 calls for (step 41) selecting an action with respect to an object displayed in the virtual world. The action is to at least one of prevent and eliminate vandalism in the virtual world. Further, the method 40 calls for (step 42) executing the action.

The methods discussed above may be implemented by the vandalism control software 120.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for operating a virtual world, the method comprising:
selecting an action with respect to an object displayed in the virtual world wherein the action is for at least one of preventing and eliminating vandalism; and
executing the action.

2. The method as in claim 1, wherein the action comprises at least one of making the object invisible and modifying the object.

3. The method as in claim 2, wherein modifying comprises at least one of converting the object to a wire frame model and displaying the object as a semi-transparent image.

4. The method as in claim 1, wherein the action comprises providing a rule for determining how the object may be affected and executing comprises applying the rule.

5. The method as in claim 4, further comprising applying the rule to a group of objects that are a subset of the object.

6. The method as in claim 1, wherein the action comprises a user providing a rule that governs how the user is to view the object and executing comprises applying the rule.

7. The method as in claim 6, wherein the rule comprises making invisible any other object that obstructs the view of the object by the user.

8. The method as in claim 6, further comprising the user allowing another user to view the object as the user views the object.

9. The method as in claim 1, wherein the action is provided by at least one of a user who created the object and a group of users.

10. The method as in claim 1, wherein executing comprises enforcing the action against at least one of another user, a group of selected users, and a group of non-selected users.

11. The method as in claim 1, wherein executing comprises attributing characteristics to the object that will prevent the object from being affected by events that are calculated using the laws of physics.

12. The method as in claim 1, further comprising eliminating the action after a period of time.

13. The method as in claim 2, further comprising making the invisible object invisible.

14. The method as in claim 1, wherein selecting comprises a user inheriting the action from a group of users to which the user belongs by one of automatically and exceeding a threshold.

15. A computer program product stored on machine readable media and comprising machine executable instructions for operating a virtual world, the product comprising instructions for:
selecting by a user of the virtual world an action with respect to an object displayed in the virtual world that at least one of prevents and eliminates vandalism in the virtual world wherein the action comprises at least one of making the object invisible and providing a rule for determining how the object may be affected;
applying the action to the object;
eliminating the action after a period of time;
making an invisible object visible; and
attributing characteristics to the object that will prevent the object from being affected by events that are calculated using the laws of physics.
